(19) United States
(12) Patent Application Publication
(10) Pub. No.: US 2008/0028109 A1
(43) Pub. Date: Jan. 31, 2008

(54) DIRECT MEMORY ACCESS CONTROL METHOD AND DIRECT MEMORY ACCESS CONTROLLER

(75) Inventor: Kenichi KAMADA, Fushimi-ku (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA KIKAI KABUSHIKI KAISHA, Kyoto-shi (JP)

(21) Appl. No.: 11/782,297

(22) Filed: Jul. 24, 2007

(30) Foreign Application Priority Data
Jul. 25, 2006 (JP) 2006-202105

(51) Int. Cl. G06F 13/28

(52) U.S. Cl. 710/25

(57) ABSTRACT

The present invention uses a Direct Memory Access controller for controlling DMA transfer for a plurality of channels whose priorities are set respectively and receives Data Request Signals for requesting data transfer for the respective channels. The DMA controller executes the DMA transfer for a channel having the highest priority from among the DMA transfer corresponding to the channels that receive the Data Request Signals. The DMA controller sets the priority of a channel used for the DMA transfer to the lowest priority. The DMA controller sets the priorities of other channels used for the DMA transfer to priorities when the DMA transfer is executed or the priorities different therefrom, which are predetermined priority other than the lowest priority.

### CROSS-REFERENCE TO RELATED APPLICATIONS

This application claims priority under 35 U.S.C. 119 to Japanese Patent Application No. 2006-202105, filed on Jul. 25, 2006, which application is hereby incorporated by reference in its entirety.

### BACKGROUND OF THE INVENTION

1. Field of the Invention

The present invention relates to a Direct Memory Access (DMA) control method and a DMA controller for executing DMA transfer for a channel having the highest priority in the DMA transfer for channels having accepted Data Request Signals.

2. Description of the Related Art

In DMA transfer, data is directly transferred between, for example, a data storage device and a plurality of devices which request data transfer without intervention of Central Processing Unit (CPU). In this case, the DMA transfer is executed for the respective devices, and a bus through which the data is transferred in each DAM transfer is referred to as a “channel”.

Even when a plurality of the channels exist, a single unit of hardware (data bus, address bus, etc.) is generally used as the bus for the data transfer. In a case in which the DMA transfer is being executed in one channel, that is, in a case in which the bus is occupied by the DMA transfer for one channel, the DMA transfer cannot be executed for other channels. Therefore, in the DMA transfer, the priority is set for the respective channels, and a channel having the highest priority is permitted to occupy the bus when the DMA transfer is requested simultaneously for the plurality of channels.

As a system of setting the priority for the respective channels, a fixed priority system in which the priority for the respective channels is set fixedly and invariantly is known. A Round-robin system for setting the priorities to the respective channels and setting the channel used for the DMA transfer to the lowest priority, and a Least Recently Used (LRU) system for setting the same to the highest priority are known. In addition, a system using a Priority Register for storing the priority of the respective channels is also known. When using the Priority Register, the priority of the respective channels is changed by re-writing a value to be set in the Priority Register.

The systems shown above have advantages and disadvantages, respectively. In order to bring out the advantages of these systems and make the disadvantages thereof to be compensated with respect to each other, Bus Arbiter in which the data is transferred by switching Round-robin system and LRU system is proposed in the related art. There is also proposed a DMA controller for an inkjet printer in which a determination unit for determining the priority of the respective channels every time when the data transfer is requested is also used with Priority Register and the fixed priority system or a Round-robin system.

### BRIEF SUMMARY OF THE INVENTION

However, a Bus Arbiter requires a complicated circuit for switching adequately between a Round-robin system and a LRU system, and complex control software. The DMA controller in the inkjet printer requires a complicated circuit and complex control software for determining the order of priority of the channels having accepted a Data Request Signal and re-writing Priority Register every time when the Data Request Signal is accepted.

With the fixed priority system and LRU system, when the requests for the DMA transfer for the channels having high priorities are issued consecutively, the requests for the DMA transfer for the channels having low priorities cannot be accepted at all. Then, Bandwidth (Data Transfer Rate) required for these channels might not be obtained, and hence the operation in the entire system may be impaired.

In a Round-robin system, since the priority of the channel which has been permitted to execute the DMA transfer is brought to the lowest level, there is a case in which the transfer request for the channel which has been permitted to execute the data transfer once is permitted only after the transfer requests for other channels have been processed. Consequently, the DMA transfer for channels which should execute the DMA transfer by priority for securing Bandwidth and channels used frequently (that is, channels having high priorities) are left over. Then, the DMA transfer for the channels having lower priorities than such channel is executed before, and hence the operation in the entire system may be impaired.

In view of such a problems, a first aspect of the present invention is that the priority of one channel used for DMA transfer is set to the lowest priority, and the priorities of other channels are set to predetermined priorities other than the lowest priority, so that the priorities suitable for the respective channels are easily set and hence the efficiency of the DMA transfer is improved as a whole.

A second aspect of the present invention includes a Register for storing Initial Values of priority of the respective channels, Set Up Values of priority of the respective channels when the DMA transfer is executed, and Present Values of priority of the respective channels. The efficiency of the DMA transfer is improved as a whole by setting the suitable priorities to the respective channels with a simple structure as the Register.

A third aspect of the present invention is that a configuration to set the values to be stored in the Register from the outside is employed, so that the further suitable priorities are set to the respective channels.

According to the invention, the Data Request Signals for requesting data transfer for the respective channels are accepted using a DMA controller for controlling the DMA transfer for a plurality of channels having the priorities set respectively thereto. The DMA controller executes the DMA transfer for the channels having the highest priority from among the DMA transfer corresponding to the channels that have accepted the Data Request Signals. The DMA controller sets the priority of the channel used for the DMA transfer to the lowest priority (first setting). The DMA controller sets the priorities of other channels used for the DMA transfer to priorities when the DMA transfer is executed or priorities different therefrom, which are predetermined priority other than the lowest priority (second setting). When the identical priority is set for the plurality of channels by the priorities set through the first setting or the second setting, the DMA controller moves the priorities of the channels other than the channels whose priorities are set through the first setting or the second setting upward (or downward).

The DMA controller is able to set the lowest priority or a predetermined priority other than the lowest priority flexibly to the channel used for the DMA transfer as the priority of this channel. Therefore, fixed values are not set for the channels used for the DMA transfer from channel to channel, and the lowest value or the highest value is not always set.

More specifically, the Initial Priority Register and the Set Up Priority Register store suitable values corresponding to the respective channels, and hence the suitable Present Values of priority corresponding to the respective channels may be stored in the Priority Register. The DMA controller is able to process the plurality of DMA transfer requests in the order of the Present Values of priority stored in the Priority Register, that is, in the suitable order.

Consequently, the priorities suitable for the respective channels may be set easily using the DMA controller having a simple structure, and hence the efficiency of the DMA transfer may be improved as a whole.

When a series of DMA transfer operations are completed or the like, the DMA controller may set the values of priority suitable for the respective channels to be stored in the Initial Priority Register and/or Set Up Priority Register respectively from the outside according to the priority of the DMA transfer to be executed next. Therefore, the suitable Present Values of priority for the respective channels may be stored in the Priority Register, and consequently, the further suitable priorities may be set to the respective channels.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a schematic diagram illustrating a configuration of a DMA controller of the present invention.

FIG. 2 is a diagram showing an example of Initial Values of priority stored in an Initial Priority Register provided in the DMA controller.

FIG. 3 is a diagram showing of an example of Set Up Values of priority stored in a Set Up Priority Register provided in the DMA controller.

FIG. 4A, FIG. 4B and FIG. 4C are diagrams showing an example of transition of Present Values of priority stored in a Priority Register provided in the DMA controller.

FIG. 5A and FIG. 5B are diagrams showing an example of transition of the Present Values of priority stored in the Priority Register provided in the DMA controller.

FIG. 6A, FIG. 6B and FIG. 6C are diagrams showing examples of the transition of the priority by the DMA controller.

FIG. 7A and FIG. 7B are diagrams showing examples of the transition of the priority by the DMA controller.

FIG. 8 is a diagram showing another example of the Set Up Values of priority stored in the Set Up Priority Register provided in the DMA controller.

FIG. 9A, FIG. 9B, and FIG. 9C are diagrams showing another example of transition of the Present Values of priority stored in the Priority Register provided in the DMA controller.

FIGS. 10A and FIG. 10B are diagrams showing still another example of transition of the Present Values of priority stored in the Priority Register provided in the DMA controller.

FIG. 11 is a diagram showing still another example of the Set Up Values of priority stored in the Set Up Priority Register provided in the DMA controller.

FIG. 12 is a diagram showing still another example of the Set Up Values of priority stored in the Set Up Priority Register provided in the DMA controller.

### DETAILED DESCRIPTION OF PREFERRED EMBODIMENTS

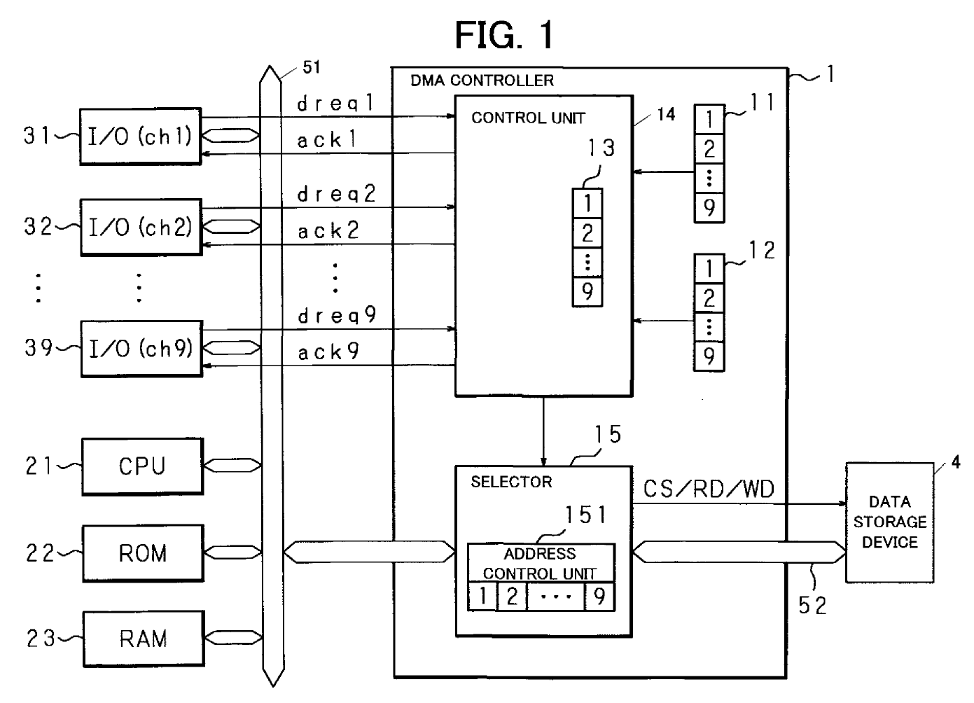

Referring now to the drawings, an embodiment of the present invention will be described in detail. FIG. 1 is a schematic diagram illustrating a configuration of a DMA controller 1 according to the present invention.

The DMA controller 1 according to the embodiment controls DMA transfer for nine channels and is integrated into a Digital Multi-Function Peripheral.

In the Digital Multi-Function Peripheral, a Central Processing Unit (CPU) 21 uses a Random Access Memory (RAM) 23 as a work area, and executes the operations of;
i) reading images on original documents by a scanner,
ii) outputting the images on the original documents by a printer,
iii) transmitting data by a Facsimile Communication Function, and
iv) outputting data received by the Facsimile Communication Function, according to a computer program and data stored in a Read Only Memory (ROM) 22.

The ROM 22, RAM 23 and DMA controller 1 are connected to the CPU 21 via a System Bus 51.

A Data Storage Device 4 employing the Synchronous Dynamic RAM (SDRAM) is directly connected to the DMA controller 1 via a data bus 52. Input-output devices (I/O) 31, 32, . . . and 39 are connected directly to the DMA controller 1 via the System Bus 51 as nine devices for requesting data transfer. That is, the I/O devices 31, 32, . . . , and 39 and the Data Storage Device 4 are not directly connected, and are connected via the DMA controller 1. Here, the data transfer means writing and reading of the data with respect to the Data Storage Device 4.

The I/O devices 31, 32, . . . , and 39 include, for example, MODEM, a scanner CODEC (Coder and Decoder), and a printing CODEC. The MODEM requests writing of facsimile image data into the Data Storage Device 4 or reading of the same from the Data Storage Device 4 to the DMA controller 1. The scanner CODEC requests the DMA controller 1 to write image data read by the scanner from the original document to the Data Storage Device 4. The printing CODEC requests reading of image data used by the printer for forming an image on a recording sheet from the Data Storage Device 4 to the DMA controller 1.

the DMA controller 1 inputs data to the Data Storage Device 4 and outputs data from the Data Storage Device 4 through the DMA transfer. The CPU 21 does not intervene in the DMA transfer. It is assumed here the pass used for data transfer for the I/O devices is a channel (ch) 1. The I/o devices outputs Data Request Signal dreq1 for requesting the data transfer for the channel ch1 to the DMA controller 1 via a signal line. The DMA controller outputs Acknowledge Signal ack1 for acknowledging the DMA transfer which is requested by the dreq1 to the I/O device 31. However, the I/O device 31 continues to output the dreq1 until the ack1 is inputted.

When writing data into the Data Storage Device 4, the I/O device 31 which receives the supply of the ack1 outputs data to be written to the System Bus 51. The DMA controller 1 supplied with the dreq1 writes the data outputted to the System Bus 51 into the Data Storage Device 4. When reading data from the Data Storage Device 4, the DMA controller 1 supplied with the dreq1 reads the data to be read from the Data Storage Device 4 and outputs the same to the System Bus 51. The I/O device 31 supplied with the ack1 receives the data outputted to the System Bus 51.

As in the case of the I/O device 31, the I/O 32, . . . , and 39 which corresponds respectively to the channels ch2, . . . , and ch9 read data using the dreq2, . . . 9 and the ack2, . . . 9 from the Data Storage Device 4, and write data to the Data Storage Device 4.

Subsequently, the configuration of the DMA controller 1 will be described in detail. The DMA controller 1 includes an Initial Priority Register 11, a Set Up Priority Register 12, a Priority Register 13, a control unit 14 and a selector 15. The Initial Priority Register 11 stores Initial Values of priority of the respective channels ch1, 2, . . . , and 9. The Set Up Priority Register 12 stores Set Up Values of priority of the respective channels ch1, 2, . . . , and 9 in the case in which the DMA transfer is executed. The Priority Register 13 stores Present Values of the priorities of the respective channels ch1, 2, . . . , and 9. The control unit 14 includes the Priority Register 13.

Since the Present Values of priority are stored in the Priority Register 13, the DMA controller 1 controls the DMA transfer for the plurality of channels whose priorities are set respectively. The DMA transfer by the DMA controller 1 will be described.

The control unit 14 of the DMA controller 1 is respectively connected to the I/O devices 31, 32, . . . , and 39 via the signal lines. The control unit 14 controls the DMA transfer by outputting the acks1, 2, . . . , and 9 to the I/O devices 31, 32, . . . , and 39 when the dreqs1, 2, . . . , and 9 are supplied from the I/O devices 31, 32, . . . , and 39.

In order to do so, the control unit 14 stores the Initial Values of the priorities stored in the Initial Priority Register 11 in the Priority Register 13 as the Present Values of priority at a predetermined timing. That is, the control unit 14 uses the values stored in the Priority Register 13 as the Initial values. The timing corresponds, for example to a moment when the CPU 21 outputs an initialize signal that indicates an instruction to initialize the Priority Register 13 to the control unit 14. More specifically, the CPU 21 outputs the initialize signal to the control unit 14 when a power of the Digital Multi-Function Peripheral is turned from off to on, when the data transfer is not executed for all the I/O devices 31, 32, . . . , and 39, when a predetermined time of the day is reached, and so on.

The control unit 14 accepts the Data Request Signals for the respective channels ch1, 2, . . . , and 9 by the supply of the dreqs1, 2, . . . , and 9 from the I/O devices 31, 32, . . . , and 39. The control unit 14 executes an accepting step for accepting the Data Request Signals for the respective channels.

When one or more dreqs are supplied, the control unit 14 reads the Present Values of priority of the channels corresponding to the supplied dregs (that is, the channels that output the dreqs to the control unit 14) from the Priority Register 13.

The control unit 14 outputs an ack corresponding to a channel having the smallest Present Value of priority read from the Priority Register 13 (having the highest priority) to the corresponding channel, and executes the DMA transfer for this channel. When the control unit 14 outputs the ack here, the supply of the dreq to the control unit 14 stops. When the channel that outputs the dreg to the control unit 14 is one, the control unit 14 outputs the ack from this channel as a matter of course.

The control unit 14 re-writes the Priority Register 13 as described later after having completed the DMA transfer for the channel to which the control unit 14 outputs the ack. After having re-written the Priority Register 13, if one or more dregs are supplied to the control unit 14, the control unit 14 reads the Present Values of priority of the channels corresponding to the supplied dreqs again from the Priority Register 13. Then, the control unit 14 outputs the ack corresponding to the channel having the smallest Present Value of priority which has read thereby to the corresponding channel, and executes the DMA transfer of this channel. After having re-written the Priority Register 13, if the dreg is not supplied to the control unit 14, the control unit 14 stands by until the dreq is supplied.

The control unit 14 which has outputted the ack controls the selector 15 and inputs or outputs the data to the Data Storage Device 4. The selector 15 is directly connected to both the System Bus 51 and the data bus 52.

The selector 15 outputs chip select signals CS and Read Enable Signals RD to the Data Storage Device 4 on the basis of the addresses of the channels ch1, 2, . . . , and 9 stored in an address control unit 151 included in the selector 15. The selector 15 outputs the data read from the Data Storage Device 4 to the I/O (any one of I/O devices 31, 32, . . . , and 39) via the data bus 52, the selector 15 itself and the System Bus 51. In the same manner, the selector 15 outputs the chip select signals CS and Write Enable Signals WD to the Data Storage Device 4 and writes the data outputted from any one of the I/O devices 31, 32, . . . , and 39 to the Data Storage Device 4 via the System Bus 51, the selector 15 itself and the data bus 52.

After having completed the DMA transfer as described above, the control unit 14 reads the Set Up Value of priority of the channel through which the control unit 14 outputs the ack from the Set Up Priority Register 12. Then, the control unit 14 re-writes the Present Value of priority stored in the Priority Register 13 on the basis of the Set Up Value of priority read from the Set Up Priority Register 12.

The Digital Multi-Function Peripheral includes an operating panel not illustrated in the drawings. The operating panel includes various function keys provided for operating the Digital Multi-Function Peripheral and a Liquid Crystal Display. A user of the Digital Multi-Function Peripheral inputs data (for example, Initial Values and/or Set Up Values of priority) to the Digital Multi-Function Peripheral using this operating panel. The CPU 21 writes the data supplied via the operating panel to the RAM 23 and reads the same from the RAM 23.

When the Initial Values of priority are supplied by the user, the CPU 21 stores the supplied data to the Initial Priority Register 11. In the same manner, when the Set Up Values of priority are supplied, the CPU 21 stores the supplied data to the Set Up Priority Register 12. In other words, the user is able to set suitable Initial Values and Set Up Values of priority according to the orders of priority of the data transfer for the I/O devices 31, 32, . . . , and 39.

When there is no supply of the Initial Values (and/or the Set Up Values) of priority by the user, the CPU 21 stores the Initial Values stored in the ROM 22 in advance in the Initial Priority Register 11. The CPU 21 stores the Set Up Values stored in the ROM 22 in advance into the Set Up Priority Register 12.

In other words, the values of priority of the respective channels ch1, 2, . . . , and 9 to be stored in the Initial Priority Register 11 and the Set Up Priority Register 12 are configured to be able to set from the outside of the DMA controller 1, respectively.

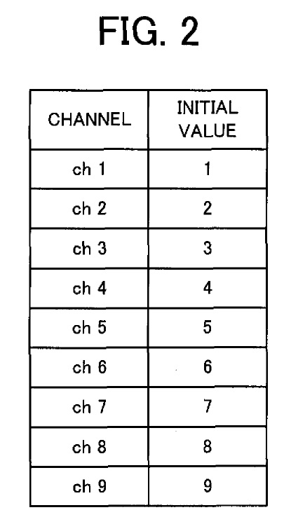

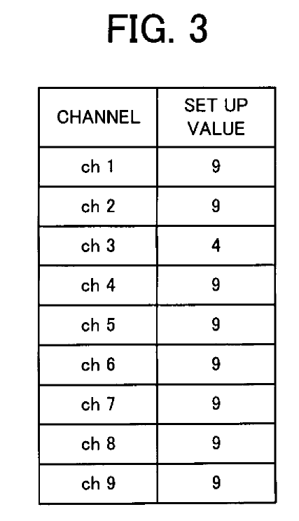

Re-writing of the Present Values of priority stored in the Priority Register 13 by the control unit 14 will now be described in detail. FIG. 2 is a diagram showing an example of the Initial Values of priority stored in the Initial Priority Register 11. FIG. 3 is a diagram showing an example of the Set Up Values of priority stored in the Set Up Priority Register 12. In this embodiment, since there exist nine channels, the priority is shown by nine natural numbers from “1” at the highest priority to “9” at the lowest priority.

As shown in FIG. 2, the Initial Priority Register 11 coordinates with the respective channels ch1, 2, . . . , and 9, and stores nine types of Initial Values from the highest priority “1” to the lowest priority “9” different from each other. FIG. 2 shows a case in which “1” is stored for the channel ch1, “2” is stored for the channel ch2 . . . , and “9”, is stored for the channel ch9 in the Initial Priority Register 11. The Initial Values of priority coordinated with the respective channels ch1, 2, . . . , and 9 are set adequately according to the priorities of the respective channels ch1, 2 . . . , and 9. In other words, the higher priorities (smaller Initial Values) are set to the channels having the higher priorities such as the channel which is required to execute the DMA transfer by priority in order to increase the bandwidth, and the frequently used channel.

As shown in FIG. 3, the Set Up Priority Register 12 stores Set up Values having any values from the highest priority “1” to the lowest priority “9” in coordination with the respective channels ch1, 2, . . . , and 9. The Set Up Values to be coordinated with the respective channels ch1, 2, . . . , and 9 may be the same or different from each other. However, the lowest priority “9” is coordinated with at least one channel. Also, the priority other than the lowest priority “9” is coordinated with at least one channel.

The channel coordinated with the lowest priority “9” is the channel having the low priority, and the channel coordinated with the priority other than the lowest priority “9” is the channel having the high priority. The higher the priority of the channel is, the higher priority (the smaller Set Up Value) is set. FIG. 3 illustrates a case in which the value “4” is stored in the Set Up Priority Register 12 for the channel ch3, and the values “9” are stored in the Set Up Priority Register 12 for the respective channels other than the channel ch3. In other words, a case in which the priority of the channel ch3 is high and the priorities of the channels other than the channel ch3 are low is shown.

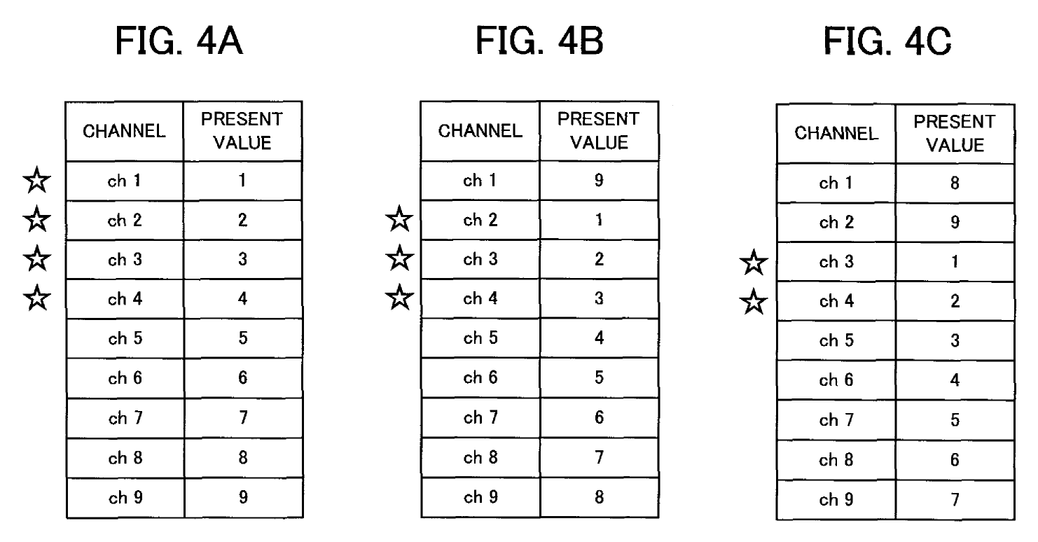

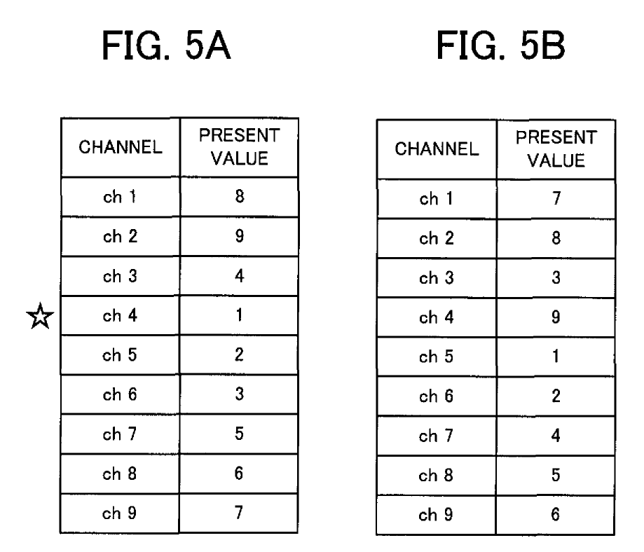

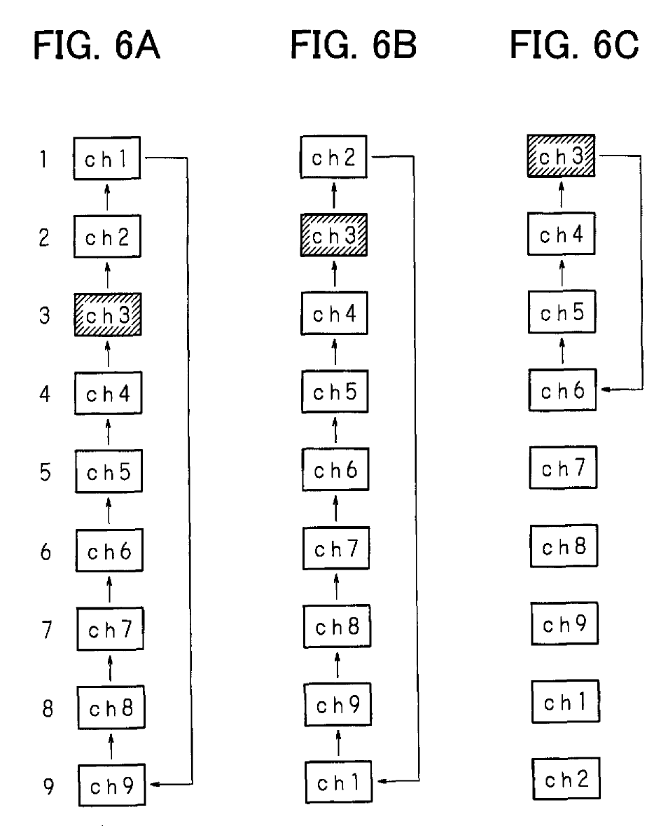

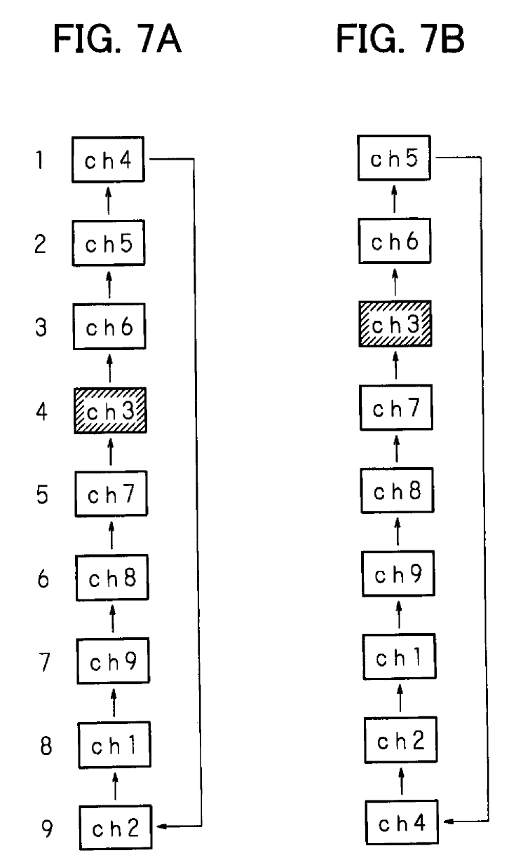

A case in which the dreqs1, 2, 3 and 4 outputted from the I/O devices 31, 32, 33 and 34 are supplied simultaneously to the control unit 14 of the DMA controller 1 when the transfer requests for the channels ch1, 2, 3 and 4 are issued simultaneously. FIG. 4 and FIG. 5 are diagrams showing examples of transition of the Present Values of priority stored in the Priority Register 13 in the case in which the values as shown in FIG. 2 and FIG. 3 are stored respectively in the Initial Priority Register 11 and the Set Up Priority Register 12. FIG. 6 and FIG. 7 are diagrams showing examples of the transition of the priority by the DMA controller 1.

FIG. 4A shows the Present Values of priority immediately after initialization of the Priority Register 13. Therefore, in the same manner as the Initial Values stored in the Initial Priority Register 11 shown in FIG. 2, the value “1” is stored in coordination with the channel ch1, the value “2” is stored in coordination with the channel ch2, . . . , and the value “9” is stored in coordination with the channel ch9. The control unit 14 reads the Present Values of the priority of the channels corresponding to the supplied dreqs1, 2, 3 and 4 from the Priority Register 13 shown in FIG. 4A. In this case, since the Present Value of priority of the channel ch1 is the smallest value “1”, the control unit 14 outputs the ack1 to the channel ch1, and executes the DMA transfer for the channel ch1. The input of the dreq1 to the control unit 14 is stopped by the output of the ack1.

After having completed the DMA transfer for the channel ch1, the control unit 14 reads the Set Up Value of priority of the channel ch1 from the Set Up Priority Register 12. In addition, the control unit 14 re-writes the Present Values of the priorities stored in the Priority Register 13 on the basis of the Set Up Value of the priority “9” read from the Set Up Priority Register 12. A result in which the control unit 14 has re-written the Present Values of the priorities stored in the Priority Register 13 at this time is shown in FIG. 4B.

FIG. 6A shows a state in which the channels from ch1 to ch9 are arranged in the order of priority. When the DMA transfer for the channel ch1 having the priority “1” has completed, the Set Up Value of priority “9” read from the Set Up Priority Register 12 is given to the channel ch1. At the time point when the priority “9” is given to the channel ch1, the same priority “9” is set to the channels ch1 and ch9, respectively (the priorities compete with each other). In this embodiment, the channel ch1 having given the priority “9” at this moment is set to the priority “9”, and the priority of the channel ch9 is moved upward to “8”.

In the same manner, the control unit 14 moves the priority of the channel ch8 upward to “7”, the priority of the channel ch7 is moved upward to “6”, . . . , and the priority of the channel ch2 is moved upward to “1”. That is, after having completed the DMA transfer for the channel ch1, the priorities of the channels from ch1 to ch9 are set respectively through the Round-robin system.

Consequently, as shown in FIG. 4B, the Priority Register 13 stores the value “9” in coordination with the channel ch1, the value “1” in coordination with the channel ch2, the value “2” in coordination with the channel ch3, . . . , and the value “8” in coordination with the channel ch9.

After having re-written the Priority Register 13, the control unit 14 reads the Present Values of the priority of the channels corresponding to the supplied dreqs2, 3 and 4 from the Priority Register 13. In this case, since the Present Value of priority of the channel ch2 is the smallest value “1”, the ack2 is outputted to the channel ch2. Then, the control unit 14 performs the DMA transfer for the channel ch2. The input of the dreq2 to the control unit 14 is stopped by the output of the ack2.

After having completed the DMA transfer for the channel ch2, the control unit 14 reads the Set Up Value of priority of the channel ch2 from the Set Up Priority Register 12. Then, the control unit 14 re-writes the Present Values of the priorities stored in the Priority Register 13 on the basis of the Set Up Value of the priority “9” read from the Set Up Priority Register 12. A result in which the control unit 14 has re-written the Present Values of the priorities stored in the Priority Register 13 at this time is shown in FIG. 4C.

FIG. 6B shows a state in which the Set Up Value of priority “9” read from the Set Up Priority Register 12 is given to the channel ch2 when the DMA transfer for the channel ch2 having the priority “1” is completed. In this case as well, the priorities of the channels from ch1 to ch9 respectively are set through the Round-robin system. As shown in FIG. 4C, the Priority Register 13 stores the value “8” in coordination with the channel ch1, the value “9” for the channel ch2, the value “1” for the channel ch3, the value “2” for the channel ch4, . . . , and the value “7” for the channel ch9.

After having re-written the Priority Register 13, the control unit 14 reads the Present Values of priority of the channels corresponding to the supplied dreqs3 and 4 from the Priority Register 13. In this case, since the Present Value of priority of the channel ch3 is the smallest value “1”, the ack3 is outputted to the channel ch3, and the DMA transfer for the ch3 is executed. The input of the dreq3 for the control unit 14 is stopped by the output of the ack3.

After having completed the DMA transfer for the channel ch3, the control unit 14 reads the Set Up Value of priority of the channel ch3 from the Set Up Priority Register 12. In addition, the control unit 14 re-writes the Present Value of priority stored in the Priority Register 13 on the basis of the Set Up Value of priority “4” read from the Set Up Priority Register 12. A result in which the control unit 14 has re-written the Present Values of the priorities stored in the Priority Register 13 at this time is shown in FIG. 5A.

FIG. 6C shows a state in which the Set Up Value of priority “4” read from the Set Up Priority Register 12 is given to the channel ch3 when the DMA transfer of the channel ch3 in the priority “1” is completed. At the time when the priority “4” is given to the channel ch3, the same priority “4” is given to the channels ch3 and ch6 respectively. In this embodiment, the channel ch3 given with the priority “4” at this moment is set to the priority “4”, and the priority of the channel ch6 is moved upward to “3”.

In the same manner, the priority of the channel ch5 is moved upward to “2”, and the priority of the channel ch4 is moved upward to “1”. That is, after having completed the DMA transfer of the channel ch1, the priorities of the respective channels ch3 to ch6 are set through the Round-robin system. Since the priorities of the channels from ch7 to ch9 and channels ch1 and 2 do not compete with each other, the control unit 14 does not re-write the priority.

Consequently, as shown in FIG. 5A, the Priority Register 13 stores the value “8” for the channel ch1, the value “9” for the channel ch2, the value “4” for the channel ch3, the value “1” for the channel ch4, the value “2” for the channel ch5, the value “3” for the channel ch6, the value “5” for the channel ch7, and the value “6” for the channel ch8, and the value “7” for the channel ch9.

After having re-written the Priority Register 13, the control unit 14 reads the Present Value of the priority of the channel corresponding to the supplied dreq4 from the Priority Register 13. In this case, since the Present Value of priority of the channel ch4 is the smallest value “1”, the ack4 is outputted to the channel ch4, and the DMA transfer of the channel ch4 is executed. The input of the dreq4 to the control unit 14 is stopped by the output of the ack4.

After having completed the DMA transfer of the channel ch4, the control unit 14 reads the Set Up Value of priority of the channel 4 from the Set Up Priority Register 12. In addition, the control unit 14 re-writes the Present Value of priority stored in the Priority Register 13 on the basis of the Set Up Value “9” of priority read from the Set Up Priority Register 12. A result in which the control unit 14 has re-written the Present Values of priority stored in the Priority Register 13 is shown in FIG. 5B.

FIG. 7A shows a state in which the Set Up Value of priority “9” read from the Set Up Priority Register 12 is given to the channel ch4 when the DMA transfer for the channel ch4 having the priority “1” is completed. In this case as well, the priorities of the channels from ch1 to ch9 respectively are set through the Round-robin system. Consequently, as shown in FIG. 5B, the Priority Register 13 stores the value “7” for the channel ch1, the value “8” for the channel ch2, the value “3” for the channel ch3, the value “9” for the channel ch4, . . . , and the value “6” for the channel ch9.

In this state as well, FIG. 7B shows a state in which the Set Up Value of priority “9” read from the Set Up Priority Register 12 is given to the channel ch5 when the DMA transfer of the channel ch5 having the priority “1” is completed. In this case as well, the control unit 14 sets the respective priorities of the channels from ch1 to ch9 through the Round-robin system.

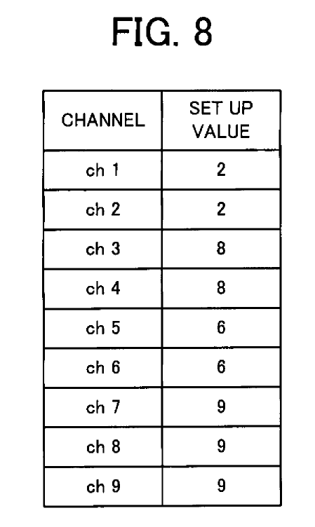

FIG. 8 is a diagram showing another example of the Set Up Values of priority stored in the Set Up Priority Register 12. FIG. 8 shows a case in which the value “2” is stored in coordination with the channels ch1 and 2 having the highest priority, the value “6” is stored in coordination with the channels ch5 and 6 having the second highest priority, the values “8” are stored in coordination with the channels ch3 and 4 having the low priority, and the values “9” are stored in coordination with the channels ch7, 8 and 9 having the lower priority.

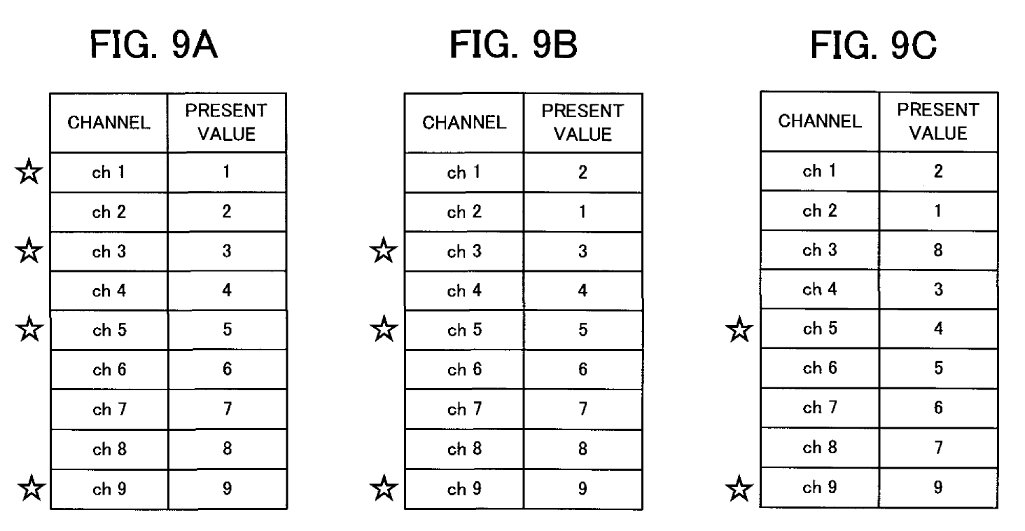

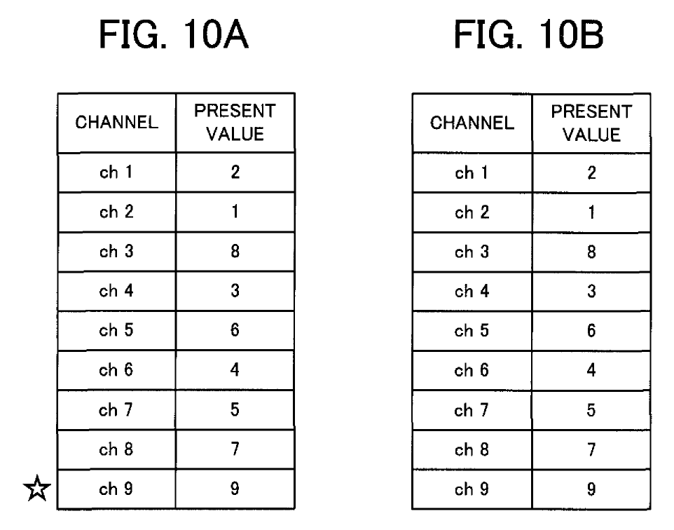

A case in which the transfer requests for the channels ch1, 3, 5 and 9 are issued simultaneously, that is, the dreqs1, 3, 5 and 9 outputted from the I/O devices 31, 33, 35 and 39 are supplied simultaneously to the control unit 14 of the DMA controller 1 will be described below. FIG. 9 and FIG. 10 are diagrams showing another examples of transition of the Present Values of priority stored in the Priority Register 13 in a case in which the values as shown in FIG. 2 and FIG. 8 are stored respectively in the Initial Priority Register 11 and the Set Up Priority Register 12.

FIG. 9A shows the Present Values of priority immediately after initialization of the Priority Register 13. Therefore, the value “1” for the channel ch1, the value “2” for the channel ch2, . . . , the value “9” for the channel ch9 are stored in the Priority Register 13 as in the case of the Initial Value stored in the Initial Priority Register 11 shown in FIG. 2. The control unit 14 reads the Present Values of priority of the channels corresponding to the supplied dreqs1, 3, 5 and 9 from the Priority Register 13 shown in FIG. 9A. In this case, since the Present Value of priority of the channel ch1 is the smallest value “1”, the ack1 is outputted to the channel ch1, and the DMA transfer for the channel ch1 is executed. Since the control unit 14 outputs the ack1, the input of the dreq1 for the control unit 14 is stopped.

After having completed the DMA transfer for the channel ch1, the control unit 14 reads the Set Up Value of priority of the channel ch1 from the Set Up Priority Register 12. In addition, the control unit 14 re-writes the Present Value of priority stored in the Priority Register 13 on the basis of the Set Up Value of priority “2” read from the Set Up Priority Register 12. In other words, after having completed the DMA transfer for the channel ch1, the priorities of the channels ch1 and ch2 are set through the Round-robin system. Here, since the priorities of the respective channels ch3 to ch9 do not conflict with each other, the priority is not re-written. A result in which the control unit 14 has re-written the Present Values of priority stored in the Priority Register 13 at this time is shown in FIG. 9B.

After having re-written the Priority Register 13, the controller 14 reads the Present Values of priority of the channels corresponding to the supplied dreqs3, 5 and 9 from the Priority Register 13. In this case, since the Present Value of priority of the channel ch3 is the smallest value “3”, the control unit 14 outputs the ack3 to the channel ch3. The control unit 14 executes the DMA transfer for the channel ch3. Since the control unit 14 outputs the ack3, the input of the dreq3 to the control unit 14 is stopped.

After having completed the DMA transfer for the channel ch3, the control unit 14 reads the Set Up Value of priority of the channel ch3 from the Set Up Priority Register 12. In addition, the control unit 14 re-writes the Present Value of priority stored in the Priority Register 13 on the basis of the Set Up Value of priority “8” read from the Set Up Priority Register 12.

After having completed the DMA transfer for the channel ch3, the priorities of the respective channels ch3 to ch8 are set through the Round-robin system, and the priorities of the respective channels ch1, ch2 and ch9 do not change. A result in which the control unit 14 has re-written the Present Value of priority stored in the Priority Register 13 is shown in FIG. 9C.

After having re-written the Priority Register 13, the control unit 14 reads the Present Values of priority of the channels corresponding to the supplied dreqs5 and 9 from the Priority Register 13. In this case, since the Present Value of priority of the channel ch5 is the smallest value “4”, the control unit 14 outputs the ack5 to the channel ch5, and the control unit 14 executes the DMA transfer for the channel ch5. Since the control unit 14 outputs the ack5, the input of the dreq5 to the control unit 14 is stopped.

After having completed the DMA transfer for the channel ch5, the control unit 14 reads the Set Up Value of priority of the channel ch5 from the Set Up Priority Register 12. In addition, the control unit 14 re-writes the Present Value of priority stored in the Priority Register 13 on the basis of the Set Up Value of priority “6” read from the Set Up Priority Register 12.

After having completed the DMA transfer for the channel ch5, the priorities of the channels ch5 to ch7 are set through the Round-robin system, and the priorities of the channels from ch1 to ch4 and from ch8 to ch9 do not change. A result in which the control unit 14 has re-written the Present Values of the priorities stored in the Priority Register 13 at this time is shown in FIG. 10A.

Assuming that the Set Up Value of priority read from the Set Up Priority Register 12 is “4” after having completed the DMA transfer for the channel ch5 (that is, in the state shown in FIG. 9C), this value and the Present Value of priority stored in the Priority Register 13 for the channel ch5 are the same, and hence the priority of the channels ch1 to ch9 do not change. In other words, the priorities of the respective channels from ch1 to ch9 are set according to the fixed priority system.

After having re-written the Priority Register 13, the control unit 14 reads the Present Value of priority of the channel corresponding to the supplied dreq9 from the Priority Register 13 (FIG. 10A). In this case, since the Present Value of priority of the channel ch9 is the lowest value “9”, the control unit 14 outputs the ack9 to the channel ch9, and the control unit 14 executes the DMA transfer for the channel ch9. Since the control unit 14 outputs the ack9, the input of the dreq9 for the control unit 14 is stopped.

After having completed the DMA transfer for the channel ch9, the control unit 14 reads the Set Up Value of priority of the channel ch9 from the Set Up Priority Register 12. In addition, the control unit 14 re-writes the Present Values of priority stored in the Priority Register 13 on the basis of the Set Up Value of the priority “9” read from the Set Up Priority Register 12.

However, since the Set Up Value of priority “9” read from the Set Up Priority Register 12 is equal to the Present Value of priority “9” stored in the Priority Register 13 in coordinate with the channel ch9, the priorities of the channels from ch1 to ch9 do not change. That is, the priorities of the channels from ch1 to ch9 are set according to the fixed priority system. A result in which the control unit 14 has re-written the Present Values of priority stored in the Priority Register 13 is shown in FIG. 10B.

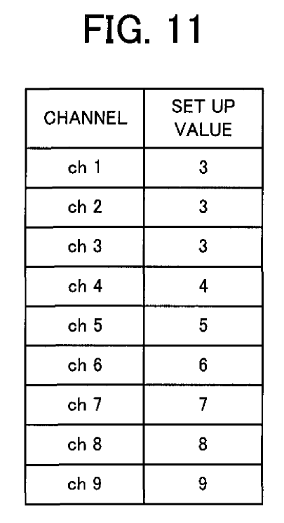

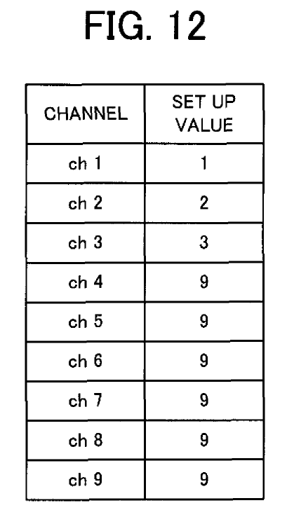

FIG. 11 and FIG. 12 are diagrams showing still another examples of the Set Up Values of priority stored in the Set Up Priority Register 12. FIG. 11 shows a case in which the value “3” is stored for the channels ch1, 2 and 3, the value “4” is stored for the channel ch4, the value “5” is stored for the channel ch5, . . . , and the value “9” is stored for the channel ch9, respectively. FIG. 12 shows a case in which the value “1” is stored for the channel ch1, the value “2” is stored for the channel ch2, the value “3” is stored for the channel ch3, and the values “9” is stored for the channels ch4, 5, . . . , 9, respectively.

When the values as shown in FIG. 2 and FIG. 11 are stored in the Initial Priority Register 11 and Set Up Priority Register 12, the Present Values of priority of the channels ch1, 2 and 3 stored in the Priority Register 13 are set according to the Round-robin system, and the Present Values of priority of the channels ch4, 5, . . . , and 9 are set according to the fixed priority system. On the other hand, when the values as shown in FIG. 2 and FIG. 12 are stored in the Initial Priority Register 11 and the Set Up Priority Register 12, the Present Values of priority of the channels ch1, 2 and 3 stored in the Priority Register 13 are set through the fixed priority system, and the Present Values of priority of the channels ch4, 5, . . . , and 9 are set through the Round-robin system.

The DMA control method as described thus far sets the priorities for the respective channels basically according to the Round-robin system, and the priority after having completed the DMA transfer is set to the lowest priority or to the priority other than the lowest priority. Therefore, the priorities of the channels having the high priority, that is, the channels required to execute the DMA transfer by priority for widening the bandwidth, or the frequently used channels do not excessively lowered. Consequently, performance of the entire system is improved.

In addition, the priority after having completed the DMA transfer may be set for the respective channels from the CPU (host) side. Therefore, the performance of the entire system is further improved by setting the priorities adequately according to the condition.

When the Set Up Values of the Set Up Priority Register for the respective channels are set to the lowest priority, the DMA controller is operated in the same manner as the Round-robin system, and when the same are set to the highest priority, the DMA controller is operated in the same manner as the LRU system. When the Initial Values of the Initial Priority Register for the respective channels are set to the same values of the Set Up Priority register, the DMA controller is operated in the same manner as the fixed priority system. In other words, the DMA controller of the present invention may accommodate various DMA controls flexibly.

However, when controlling in this manner, the configuration of the DMA controller according to the present invention tends to be more complex than the configurations of the DMA controllers employing the Round-robin system by itself, the LRU system by itself, or the fixed value by itself by an extent corresponding to the requirement of the Set Up Priority Register. In other words, the DMA controller according to the present invention is operated most efficiently in the case of being used in the DMA control method according to the present invention in which the predetermined priorities are set to the respective channels through the Round-robin system.

When the Set Up Values of the Set Up Priority Register for the plurality of channels are set to the lowest priority, and the Set Up Values of the Set Up Priority Register for the plurality of channels other than these channels are set to the highest priority, the DMA controller is operated as a system including the Round-robin system and the LRU system mixed. However, it is not necessary to determine switching between the Round-robin system and the LRU system, the configuration of the DMA controller is simple.

In this embodiment, although the Digital Multi-Function Peripheral including the DMA controller according to the present invention for executing the DMA control method of the present invention has been described as an example, the invention is not limited thereto. The number of channels is not limited to nine.

While the present invention has been described with respect to preferred embodiments thereof, it will be apparent to those skilled in the art that the disclosed invention may be modified in numerous ways and may assume many embodiments other than those specifically set out and described above. Accordingly, it is intended by the appended claims to cover all modifications of the present invention that fall within the true sprit and scope of the present invention.

What is claimed is:

1. A direct memory access controller for controlling a DMA transfer for a plurality of channels comprising:
an initial priority register for storing initial values of priority for the respective channels;
a set up priority register for storing set up values of priority for the respective channels in a case in which the DMA transfer is executed;
a priority register for storing present values of priority for the respective channels;
an initialize unit for storing the initial values of priority stored in the initial priority register in the priority register as the present values of priority;
an accept unit for accepting transfer request signals for requesting data transfer for the respective channels;
a first read unit for reading a present value of priority of a channel whose transfer request signal is accepted by the accept unit from the priority register;
a transfer unit for executing the DMA transfer for the channels in the order corresponding to the present values of priority read by the first read unit;
a second read unit for reading a set up value of priority of a channel used for the DMA transfer from the set up priority register when the DMA transfer for the channels is executed by the transfer unit; and
a re-write unit for re-writing the present value of priority stored in the priority register on the basis of the set up value read by the second read unit.

2. The direct memory access controller according to claim 1, wherein the priority register is initialized by initialize signals from a processor.

3. The direct memory access controller according to claim 1, wherein the priority register is initialized by an User Interface.

4. A direct memory access controller for controlling DMA transfer for a plurality of channels comprising:
means for storing initial values of priority for the respective channels;
means for storing set up values of priority of the respective channels in a case in which the DMA transfer is executed;
means for storing present values of priority of the respective channels;
means for storing the initial values of priority stored in the initial priority register in the priority register as the present values of priority;
means for accepting transfer request signals that requests data transfer for the respective channels;
means for reading a present value of priority of channel whose transfer request signal is accepted from the priority register;
means for executing the DMA transfer for the channels in the order corresponding to the read present values of priority;
means for reading the set up value of priority of the channel used for the DMA transfer from the set up priority register when the DMA transfer for the channels is executed; and
means for re-writing the present values of priority stored in the priority register on the basis of the read set up value.

5. The direct memory access controller according to claim 4, further comprising:
means for initializing the priority.

6. A direct memory access control method for controlling DMA transfer for a plurality of channels whose priorities are set respectively comprising:
accepting transfer request signals for requesting data transfer for the respective channels;
executing the DMA transfer for a channel having the highest priority from among the DMA transfer for the channels whose transfer request signals are accepted;
setting the priority of a channel used for the DMA transfer to the lowest priority;
setting the priorities of other channels used for the DMA transfer to priorities when the DMA transfer is executed or priorities different therefrom, which are predetermined priority other than the lowest priority; and
changing the priority of the channel other than the channel whose priority is set when the same priority is set for the plurality of channels by setting the priority.

7. The direct memory access control method according to claim 6, wherein changing the priority is moving the priority upward.

8. The direct memory access control method according to claim 6, wherein changing the priority is moving the priority downward.

9. The direct memory access control method according to claim 6, further comprising:
setting the Initial Value of priority.
